(19) United States
(12) Patent Application Publication
(10) Pub. No.: US 2017/0097673 A1
(43) Pub. Date: Apr. 6, 2017

(54) COMPUTER SYSTEM AND METHOD PROVIDING BOTH MAIN AND AUXILIARY POWER OVER A SINGLE POWER BUS

(71) Applicant: Lenovo Enterprise Solutions (Singapore) Pte. Ltd., Singapore (SG)

(72) Inventors: Delali Dogbey, Durham, NC (US); Randhir S. Malik, Cary, NC (US); Brian C. Totten, Durham, NC (US)

(21) Appl. No.: 14/872,666

(22) Filed: Oct. 1, 2015

(51) Int. Cl. G06F 1/32

(52) U.S. Cl. CPC G06F 1/3296; G06F 1/3206

(57) ABSTRACT

A computer system includes power-consuming components, a power supply providing power to the power-consuming components, a single power bus extending from the power supply to each of the system components, and a service processor in communication with the components and the power supply. The service processor sends a turn on signal to the power supply in response to detecting activity of the power-consuming components and sends a sleep mode signal to the power supply in response to detecting inactivity of the power-consuming components. The power supply supplies power to the single power bus at a first voltage in response to receiving the turn on signal and supplies power to the single power bus at a second voltage in response to receiving the sleep mode signal, wherein the first voltage is greater than the second voltage.

### BACKGROUND

Field of the Invention

The present invention relates to power distribution in a computer system, and more specifically relates to power distribution from a power supply to components within an individual node.

Background of the Related Art

A computer system such as a personal computer, laptop computer or server will include many power-consuming components. These components may vary in their performance and function, but they each contribute to the total amount of power consumed by the computer system. Since the cost of the power consumed by the computer system is a significant portion of the cost of ownership, it is generally desirable to reduce power consumption during periods of time that there is low or no workload placed on the computer system.

Sleep mode, also referred to as standby mode or suspend mode, is a low power mode for a computer system that significantly reduces power consumption below a fully operational level. However, sleep mode allows the computer system to resume operations without having to do a significant amount of work, such a rebooting. This is done by storing the machine state in memory and cutting power to subsystems that are not doing any work. Since operation of one or more processors may be responsible for a majority of the power consumption of a computer system, cutting power to the processors can save a large amount of power. Still, the computer system may be quickly resumed in response to a wake-up event, such as using the keyboard, moving a mouse or other pointing device, pressing a power button, or opening a laptop.

A computer system will include a main power bus that distributes power for the main (in-band) components of the system and an auxiliary power bus that distributes power to the supervisory (out-of-band) components. A power supply for the computer system will have an input for receiving alternating current, an AC to DC converter, a main power circuit that provides 12 Volts at 0-100 Amps to the main power bus, and an auxiliary power circuit that provides 12 Volts at up to 3 Amps to the auxiliary power bus.

### BRIEF SUMMARY

One embodiment of the present invention provides a computer system, comprising a plurality of power-consuming components, a power supply having a power output for powering the power-consuming components, a single power bus extending from the power output to each of the system components, and a service processor in communication with the power-consuming components and the power supply. The service processor sends a turn on signal to the power supply in response to detecting activity of the power-consuming components and sends a sleep mode signal to the power supply in response to detecting inactivity of the power-consuming components. In addition, the power supply supplies power to the single power bus at a first voltage in response to receiving the turn on signal and supplies power to the single power bus at a second voltage in response to receiving the sleep mode signal, wherein the first voltage is greater than the second voltage.

Another embodiment of the present invention provides a method, comprising a service processor within a computer system sending a turn on signal to a power supply with the computer system in response to detecting activity of the computer system, and the power supply supplying power on a power bus at a first voltage in response to receiving the turn on signal, wherein the power bus distributes power to a plurality of components within the computer system. The method further comprises the service processor sending a sleep mode signal to the power supply in response to detecting inactivity of the computer system, and the power supply supplying power on the power bus at a second voltage in response to receiving the sleep mode signal, wherein the first voltage is greater than the second voltage.

### BRIEF DESCRIPTION OF THE SEVERAL VIEWS OF THE DRAWINGS

FIG. 1 is a diagram of a computer system in accordance with one embodiment of the present invention.

FIG. 2 is a flowchart of a method in accordance with another embodiment of the present invention.

### DETAILED DESCRIPTION

One embodiment of the present invention provides a computer system, comprising a plurality of power-consuming components, a power supply having a power output for powering the power-consuming components, a single power bus extending from the power output to each of the system components, and a service processor in communication with the power-consuming components and the power supply. The service processor sends a turn on signal to the power supply in response to detecting activity of the power-consuming components and sends a sleep mode signal to the power supply in response to detecting inactivity of the power-consuming components. In addition, the power supply supplies power to the single power bus at a first voltage in response to receiving the turn on signal and supplies power to the single power bus at a second voltage in response to receiving the sleep mode signal, wherein the first voltage is greater than the second voltage.

The computer system may be any individual node, such as a personal computer, laptop computer, server or network switch. Accordingly, the plurality of power-consuming components may, without limitation, include one or more processors, volatile and non-volatile memory, data storage devices, and input and output devices. In a preferred embodiment, the service processor communicates with the power supply over a power management bus (PMBus) using power management bus commands. In one option, the power-consuming components include volatile memory, wherein the power supply supplies enough power to maintain the data stored in the volatile memory in the sleep mode at the second voltage.

In various embodiments, the first voltage is suitable for powering all of the power-consuming components in the computer system in a normal mode, and the second voltage is suitable for powering only the standby circuits that to be utilized in the sleep mode. In one non-limiting example, the first voltage is 12 Volts and the second voltage is from 5 to 8 Volts.

Another embodiment of the present invention provides a method, comprising a service processor within a computer system sending a turn on signal to a power supply with the computer system in response to detecting activity of the computer system, and the power supply supplying power on a power bus at a first voltage in response to receiving the turn on signal, wherein the power bus distributes power to a plurality of components within the computer system. The method further comprises the service processor sending a sleep mode signal to the power supply in response to detecting inactivity of the computer system, and the power supply supplying power on the power bus at a second voltage in response to receiving the sleep mode signal, wherein the first voltage is greater than the second voltage.

In one embodiment of the method, data is stored in volatile memory of the computer system at the second voltage. Preferably, the power supply may supply enough power to maintain the data stored in the volatile memory in the sleep mode at the second voltage. Accordingly, the volatile memory holds data during sleep mode so that the computer system can quickly resume operation in the normal mode in response to the turn on signal. In a further option, the method may further include the power supply varying the amount of power supplied on the power bus during the sleep mode in response to an amount of volatile memory storing data.

Various embodiments of the present invention improve electrical efficiency by lowering the bus voltage below 12 Volts during the sleep mode. Other embodiments of the present invention reduce manufacturing costs by providing only a single power bus (i.e., eliminating the auxiliary power bus that is typically used to distribute power to various components when the computer system is in a sleep mode). Still further, embodiments of the present invention have the capacity to distribute sufficient amounts of power, even in the sleep mode, to store information in volatile memory of the system.

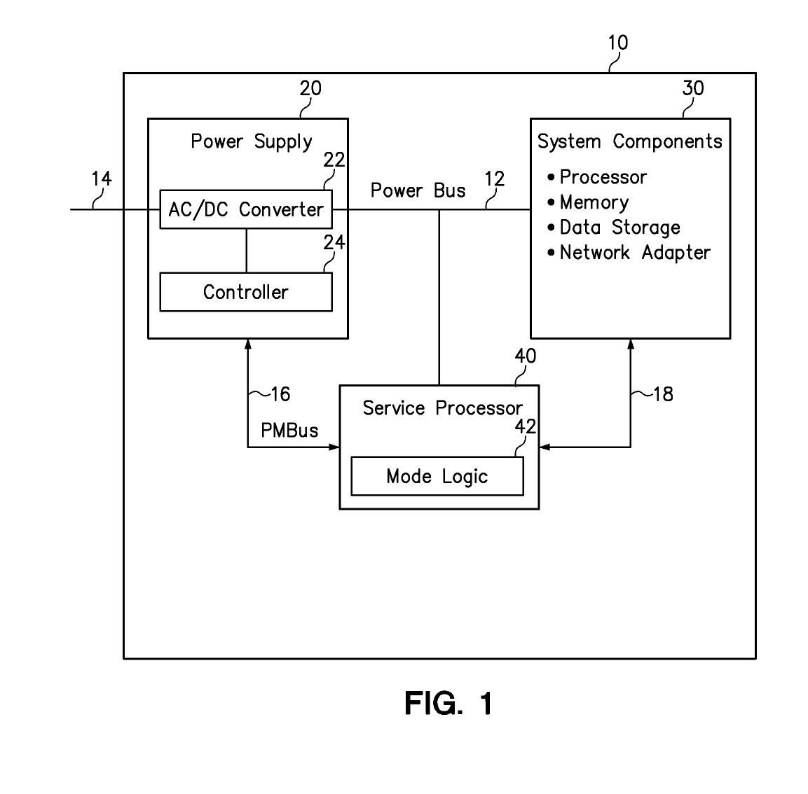

FIG. 1 is a diagram of a computer system 10 in accordance with one embodiment of the present invention. The computer system 10 includes a power supply 20, system components 30, and a service processor 40. The power supply 20 includes an AC to DC converter circuit (“AC/DC converter”) 22 that is controlled by a controller 24. The AC/DC converter 22 receives alternating current (AC) over an AC power line 14 and provides direct current (DC) onto a power bus 12 that distributions power to the system components 30 and the service processor 40. The system components 30 may include, without limitation, one or more processor, volatile and/or non-volatile memory, a data storage device, and a network adapter.

The service processor 40, such as a baseboard management controller (BMC), monitors the system components 30 (as represented by a sensor/communication line 18) and executes mode logic 42 along with other functions. For example, if the service processor 40 detects that the system components 30 are inactive, then the mode logic 42 will cause the service processor 40 to output a “sleep mode” signal or command on a power management bus (PMBus) 16 to the controller 24 of the power supply 20. The controller 24 will then control the AC/DC converter 22 to reduce the voltage on the power bus 12. Conversely, if the system is already in a sleep mode and the service processor 40 detects that one or more of the system components 30 are active, then the mode logic 42 will cause the service processor 40 to output a “turn on signal” or a “normal mode” signal or command on the power management bus (PMBus) 16 to the controller 24 of the power supply 20. The controller 24 will then control the AC/DC converter 22 to increase the voltage on the power bus 12. Accordingly, the power supply supplies power on the power bus at a first voltage in response to receiving the turn on signal, and supplies power on the power bus at a second voltage in response to receiving the sleep mode signal, wherein the first voltage is greater than the second voltage.

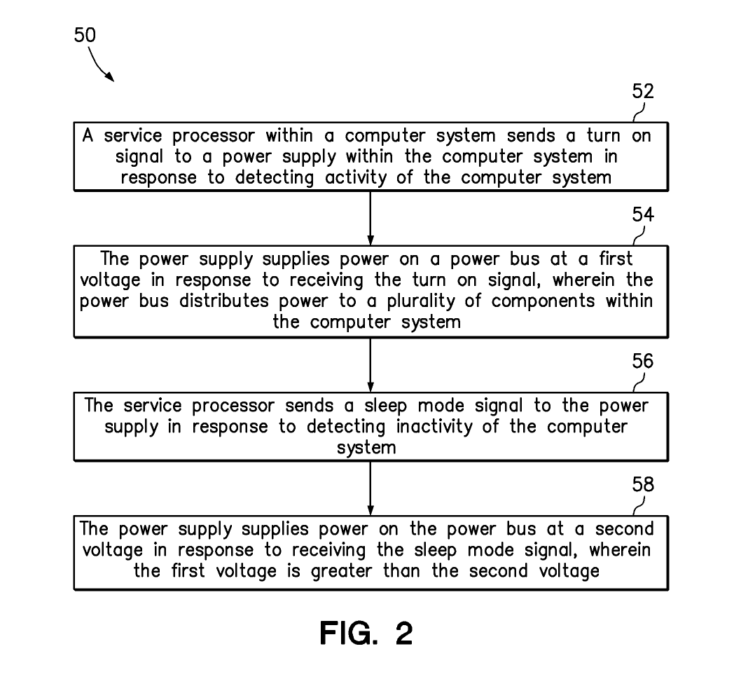

FIG. 2 is a flowchart of a method 50 in accordance with another embodiment of the present invention. In step 52, a service processor within a computer system sends a turn on signal to a power supply with the computer system in response to detecting activity of the computer system. In step 54, the power supply supplies power on a power bus at a first voltage in response to receiving the turn on signal, wherein the power bus distributes power to a plurality of components within the computer system. In step 56, the service processor sends a sleep mode signal to the power supply in response to detecting inactivity of the computer system. In step 58, the power supply supplies power on the power bus at a second voltage in response to receiving the sleep mode signal, wherein the first voltage is greater than the second voltage.

For example, the power bus voltage may be transitioned to a lower voltage level (such as 5-8V) which is suitable to power only the standby/auxiliary circuits when the sleep mode signal is received from a service processor within the system. When the turn on signal is received from the service processor, the power supply is programmed to a higher voltage (such as 12V) which is suitable for powering the system in normal mode. So, the power supply may be operated to provide two different voltages on the same power bus depending upon whether the computer system is in a sleep mode or a normal mode.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing. Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention may be described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, and/or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, components and/or groups, but do not preclude the presence or addition of one or more other features, integers, steps, operations, elements, components, and/or groups thereof. The terms “preferably,” “preferred,” “prefer,” “optionally,” “may,” and similar terms are used to indicate that an item, condition or step being referred to is an optional (not required) feature of the invention.

The corresponding structures, materials, acts, and equivalents of all means or steps plus function elements in the claims below are intended to include any structure, material, or act for performing the function in combination with other claimed elements as specifically claimed. The description of the present invention has been presented for purposes of illustration and description, but it is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

1. A method, comprising:
a service processor within a computer system sending a turn on signal to a power supply with the computer system in response to detecting activity of the computer system;
the power supply supplying power on a power bus at a first voltage in response to receiving the turn on signal, wherein the power bus distributes power to a plurality of components within the computer system;
the service processor sending a sleep mode signal to the power supply in response to detecting inactivity of the computer system; and
the power supply supplying power on the power bus at a second voltage in response to receiving the sleep mode signal, wherein the first voltage is greater than the second voltage.

2. The method of claim 1, wherein the first voltage is 12 Volts.

3. The method of claim 2, wherein the second voltage is from 5 to 8 Volts.

4. The method of claim 1, further comprising:
storing data in volatile memory of the computer system at the second voltage.

5. The method of claim 4, wherein the power supply supplies enough power to maintain the data stored in the volatile memory in the sleep mode at the second voltage.

6. The method of claim 1, wherein the computer system is selected from a compute node, switch, and server.

7. The method of claim 1, wherein the turn on signal and the sleep mode signal are power management bus commands.

8. The method of claim 1, wherein the second voltage is suitable to power only the standby circuits.

9. The method of claim 1, wherein the first voltage is suitable for powering the computer system in normal mode.

10. The method of claim 1, further comprising:
the power supply varying the amount of power supplied on the power bus during the sleep mode in response to an amount of volatile memory storing data.

11. A computer system, comprising:
a plurality of power-consuming components;
a power supply having a power output for powering the power-consuming components;
a single power bus extending from the power output to each of the system components;
a service processor in communication with the power-consuming components and the power supply, wherein the service processor sends a turn on signal to the power supply in response to detecting activity of the power-consuming components and sends a sleep mode signal to the power supply in response to detecting inactivity of the power-consuming components, and wherein the power supply supplies power to the single power bus at a first voltage in response to receiving the turn on signal and supplies power to the single power bus at a second voltage in response to receiving the sleep mode signal, wherein the first voltage is greater than the second voltage.

12. The computer system of claim 11, wherein the first voltage is 12 Volts.

13. The computer system of claim 12, wherein the second voltage is from 5 to 8 Volts.

14. The computer system of claim 11, wherein the power-consuming components include volatile memory, and wherein the power supply supplies enough power to maintain the data stored in the volatile memory in the sleep mode at the second voltage.

15. The computer system of claim 11, wherein the service processor communicates with the power supply using power management bus commands.

16. The computer system of claim 11, wherein the first voltage is suitable for powering all of the power-consuming components, and wherein the second voltage is suitable for powering only the standby circuits.
